(19) United States
(12) Patent Application Publication
(10) Pub. No.: US 2009/0316325 A1
(43) Pub. Date: Dec. 24, 2009

(54) Silicon emitters for ionizers with high frequency waveforms

(75) Inventor: Peter Gefter, South San Francisco, CA (US)

Correspondence Address: John E. Menear;c/o MKS, Ion Systems, Suite 100, 1750 North Loop Road, Alameda, CA, 94502, US

(73) Assignee: MKS Instruments

(21) Appl. No.: 12/456,526

(22) Filed: Jun. 18, 2009

Related U.S. Application Data
(60) Provisional application No. 61/132,422, filed on Jun. 18, 2008.

(51) Int. Cl. H01T 23/00

(52) U.S. Cl. 361/231

(57) ABSTRACT

A method of creating low-particle ionizers by combining silicon-containing emitters and a high frequency AC voltage. The high frequency AC voltage provides voltage and current to the corona emitters of the ionizer. Within the scope of this invention, emitters or emitter surfaces contain 47% by weight (or more) of silicon. The combination of silicon-containing emitters and a high frequency AC voltage produces ionizers that are cleaner than prior art ionizers, based on particles greater than 10 nanometers. This improvement in cleanliness has been experimentally determined.

### CROSS-REFERENCE TO RELATED APPLICATIONS

This application claims priority to U.S. Provisional Application 61/132,422 filed Jun. 18, 2008 entitled “SILICON EMITTERS FOR IONIZERS WITH HIGH FREQUENCY WAVEFORMS”.

### STATEMENT REGARDING FEDERALLY SPONSORED RESEARCH

Not Applicable

### REFERENCE TO A MICROFICHE APPENDIX

Not Applicable

### BACKGROUND OF THE INVENTION

1. Field of the Invention

This invention relates to AC ionizers for that are used for static charge control. More specifically, the invention is targeted at the need for low-particle-count ionizers within the semiconductor industry.

With AC ionizers, each emitter receives a positive voltage during one time period and a negative voltage during another time period. Hence, each emitter generates both positive and negative ions.

Both positive and negative ions are directed toward a charged target for the purpose of neutralizing the charge on that target.

2. Description Of Related Art

Ion emitters within AC ionizers generate both positive and negative ions into the surrounding air or gas media. To generate ions, the peak amplitude of applied AC voltage must be high enough to produce a corona discharge between at least two electrodes, where at least one of them is an ion emitter and at least one of them is a reference electrode.

Along with useful ions, emitters can produce unwanted particles. In a semiconductor process, particles correlate with defects, reliability problems, and lost profits.

Two known factors independently influence the quantity of unwanted particles. The first factor is the material used for emitter construction. The second factor is the profile of the power (voltage and current) that is applied to the emitters.

Power waveforms can be used to control the voltage profile that is applied to the emitters by the high voltage power supplies.

The most basic power waveform is a high frequency high voltage output from a high frequency power supply. This high voltage output may be continual rather than continuous That is, the voltage output may be turned off periodically.

The composition of emitters is well known to affect particle levels of ionizers. Common materials include tungsten, titanium, silicon oxide, single crystal silicon, silicon carbide, and nickel plated metals. This list is not complete.

Of these materials, single crystal silicon has proven to be particularly advantageous from the viewpoint of low particle emission. Single crystal silicon has been adopted by the semiconductor market as a de-facto clean emitter standard.

Standard ionizers with single crystal silicon emitters, designed for cleanroom ceiling installation, typically produce less than 60 particles per cubic foot of air that are greater than 10 nanometer (diameter). Other emitter materials typically produce more than 200 particles per cubic foot of air that are greater than 10 nanometer (diameter). Some materials produce thousands of particles per cubic foot of air that are greater than 10 nanometer (diameter).

Although (1) material of construction and (2) application of power waveforms are known to be independently important, the prior art has not considered the benefits of strategically combining these two factors.

Recent experiments have shown that (1) the material of emitter construction and (2) the type of power waveforms do not always operate independently. The material of construction and the type of power waveform can interact. Some combinations lead to unpredictably low levels of particle generation, which is desirable.

### BRIEF SUMMARY OF THE INVENTION

Matching emitter material to the power waveform that is applied to the emitters has proven to be a novel method of achieving previously-unattainable levels of ionizer cleanliness.

The core of this invention is the combination of: (1) high frequency AC voltage, and (2) emitters whose chemical composition is at least 47% silicon by weight. This combination is particularly effective for in-line ionizers, where a flow of air or nitrogen passes by emitters in an ionizing chamber. The ionizing chamber is enclosed except for the air inlet and air outlet openings.

Using in-line designs, ionizers require only (1) the use of high frequency AC voltage and (2) silicon containing emitters to produce clean performance. The addition of low frequency voltage pulses (used for ionizers without air flow) is not needed. The air (or nitrogen or argon) suffices to move the ions from the ionizing chamber.

The high frequency voltage profile has an AC frequency of 1 to 100 kiloHertz. Peak voltages exceed the corona onset voltages (positive and negative) of the emitters. The mean voltage of the high frequency AC voltage profile is substantially zero, where “substantially zero” means 0±500 volts.

Within this instant application, voltages are defined as the difference between the ion generating electrode and the reference electrode. Ions are generated whenever the peak voltage exceeds the corona onset voltage.

Another frequency (optional) becomes pertinent when the high frequency AC voltage profile is periodic rather than continuous. That is, the high frequency AC voltage profile is generated only within predefined time intervals. In this scenario, the high frequency AC voltage is applied to the emitters during active time intervals (typically 0.1 to 0.6 seconds), but not applied during inactive time intervals. This optional frequency is essentially an on/off frequency. A normal on/off frequency range is 0.1-500 Hertz, but the frequency may lie outside this range.

Four silicon-containing emitter compositions are provided as examples. They are (a) single crystal silicon, (b) silicon carbide, (c) silicon oxide, and (d) deposited silicon.

### BRIEF SUMMARY OF THE FIGURES

FIG. 1 is a diagram of a prior art AC ionizer. The operating frequency is 60 Hertz.

FIG. 2 shows a high frequency AC voltage profile applied to emitters. The function of the high frequency AC voltage is to create ions. The example frequency shown is 18 kiloHertz. To create ions, the peak voltages (positive and negative) exceed the corona threshold voltages. As shown, the high frequency AC voltage profile is continuous, but the profile may also be non-continuous and periodic.

FIG. 3 shows ions generated inside the ionizing chamber of an in-line ionizer. The high frequency AC voltage generates the ions, and the air flow separates the ions from the emitters. Ions are delivered to a target through an outlet fitting.

FIG. 4 has been omitted.

FIG. 5 shows a side view for each of three silicon-containing emitters that are formed as a shaft with a tip. The common feature of each variation is that the tip has a smaller cross section than the shaft. The degree of sharpness and the curvature of the tip affect ionizer operating parameters, but they do not affect the scope of the instant invention.

FIG. 6 shows a silicon-containing emitter shaped as a wire or filament.

FIG. 7 shows a silicon-containing emitter shaped as a loop that fits inside an air nozzle.

### DETAILED DESCRIPTION

Experimentally, it has been shown that combining (1) silicon-containing emitters with (2) a high frequency AC voltage waveform produces a balanced ionizer that generates very few particles. The combination creates a cleanliness level that cannot be explained separately by either the silicon-containing emitters or the high frequency AC voltage waveform.

For example, with single crystal silicon emitters in a prior art balanced ionizer, roughly 60 particles per cubic foot of air greater than 10 nanometers (diameter) are expected when the emitters are connected to prior art 60 hertz power sources. The same ionizer driven by a high frequency voltage waveform typically yields less than 10 particles per cubic foot of air greater than 10 nanometers. In perspective, 10 particles per cubic foot of air greater than 10 nanometers is nominally 6 times cleaner than the cleanest prior art in-line ionizers at the time of this application.

In a contrasting example, a non-silicon-containing emitter (tungsten) was tested with a prior art power source and with a high frequency AC voltage waveform. Little cleanliness difference was found between a prior art power source and a high frequency power source. The application of a high frequency AC voltage waveform to the non-silicon-containing emitter had little benefit. Particle results in both cases were above 600 particles per cubic foot of air greater than 10 nanometers.

However, when the same tungsten emitter was coated with silicon dioxide and powered by a high frequency AC voltage waveform, the average particle count fell by a factor of 50. The silicon dioxide coating interacted favorably with the high frequency AC voltage waveform.

The performance of silicon carbide emitters within balanced ionizers also improves when powered by a high frequency AC voltage source, as opposed to prior art power sources.

Two factors consistently interact to create the observed cleanliness improvement: (1) an emitter with a silicon content of 47% by weight or more, and (2) a high frequency AC voltage waveforn.

The 47% silicon content was calculated for silicon dioxide (SiO₂), where the atomic weight of silicon is 29 and the atomic weight of oxygen is 16. Single crystal silicon, deposited silicon, and silicon carbide contain higher percentages of silicon.

The scientific basis for the particle improvement of balanced ionizers due to the interaction between silicon composition and the high frequency AC voltage waveform is currently being studied. Recognized theories of ionization do not predict or explain the experimental cleanliness observed. No theoretical explanations or rationalizations are offered in this instant application for the experimentally determined cleanliness.

However, how to make and use the instant invention is clearly understood. Prototypes have been successfully reduced to practice using commercially available emitters and electronic waveform generators. The following written description is directed toward explaining how to make and use this invention to one of ordinary skill in the static charge control field.

Low particle ionizers have utility in several industries. In particular, the semiconductor industry has a well-defined need for low particle ionizers. The ionizers are needed to minimize static charge, which can destroy semiconductor devices. Low particle generation is needed because particles also destroy semiconductor devices. Leading edge semiconductor technology is building 32 nanometer features on wafers. For 32 nanometer features, control of particles greater than 16 nanometers is needed.

Cumulative particles greater than or equal to 10 nm were measured during cleanliness testing. The particle counters did not separate particles into size ranges.

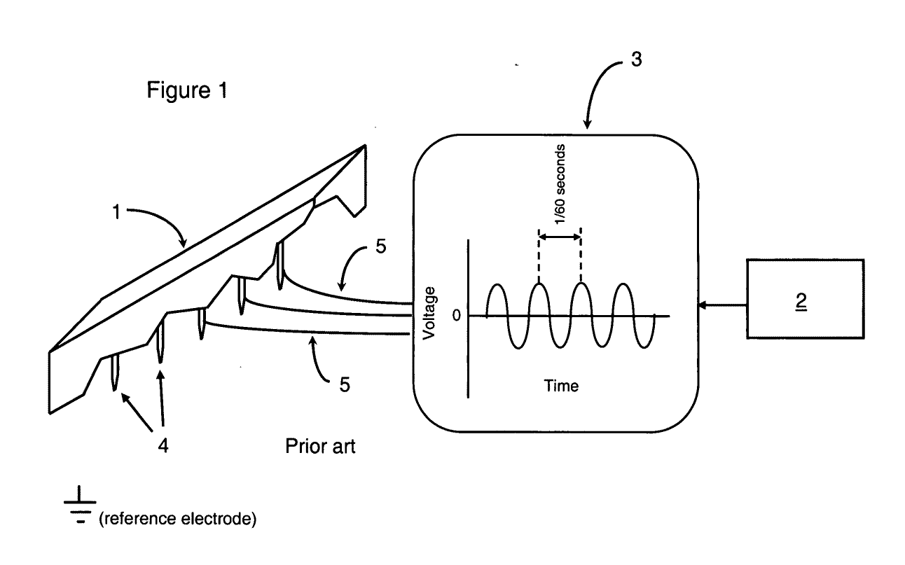

FIG. 1 shows a prior art AC ionizer 1. A high voltage AC power supply 2 supplies a prior art high voltage power profile 3 to all emitters 4 simultaneously through electrical lines 5. The frequency shown in FIG. 1 is 60 Hertz since each cycle has a period of 1/60 second. A frequency of 50 Hertz is appropriate for countries with 50 Hertz power.

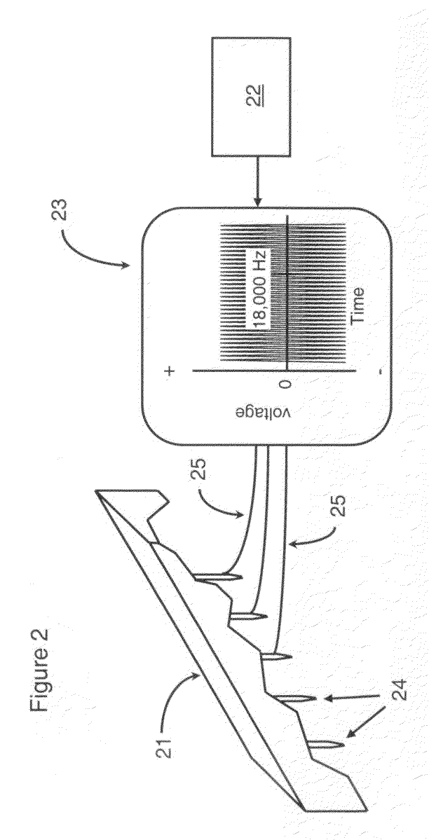

FIG. 2 again shows an AC ionizer 21, but the high voltage AC power supply 22 produces a high frequency AC voltage 23 at 1,000 to 26,000 Hertz. In some cases, the frequency range may be extended upward to 100,000 Hertz. As shown, the frequency is 18,000 Hertz. This high frequency AC voltage 23 is sufficient in itself to create a clean in-line ionizer when emitters with greater than 47% silicon are employed.

With an in-line ionizer design, the application of the high frequency AC voltage 23 to the emitters 24 through electrical lines 25 is augmented by air flow to effect charge neutralization at a distant target. Although ions are generated when the peak voltages (positive or negative) of the high frequency AC voltage 23 exceed the corona onset voltage, generated ions still need to move toward the target. Air flow serves that need.

The corona onset voltage is approximately +5000 to +6000 volts for positive ions and −4500 to −5500 volts for negative ions.

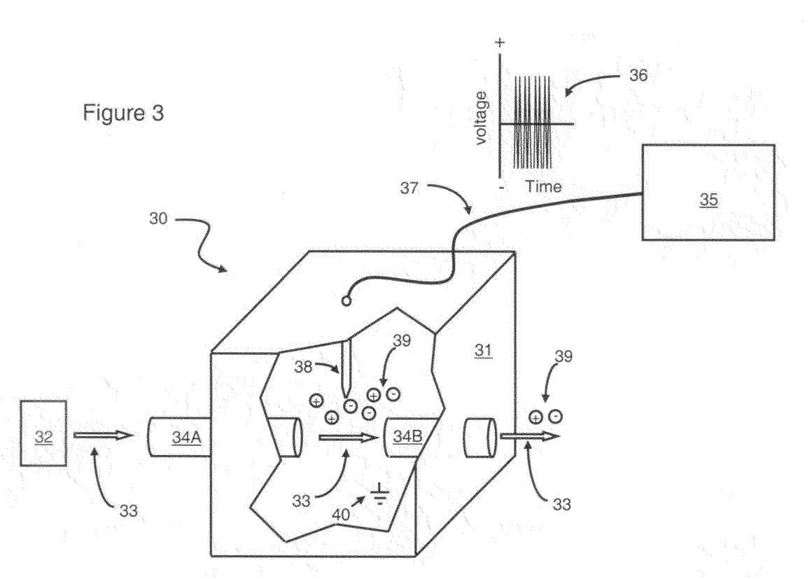

FIG. 3 shows positive and negative ions 39 created inside an in-line ionizer 30. A high voltage AC power supply 35 provides the voltage and current needed to generate the ions 39. The high voltage AC power supply 35 delivers a high frequency AC voltage 36 to the silicon emitter 38 through an electrical line 37 which penetrates the chassis 31. Voltage on the silicon emitter 38 is relative to a reference electrode 40.

A pressurized source 32 of air, nitrogen or argon is connected to the in-line ionizer 30 via an inlet fitting 34A to create an air or gas flow 33. The air or gas flow 33 entrains positive and negative ions 39 and carries the ions 39 through the outlet fitting 34B toward a target.

FIG. 4 has been omitted from this provisional application.

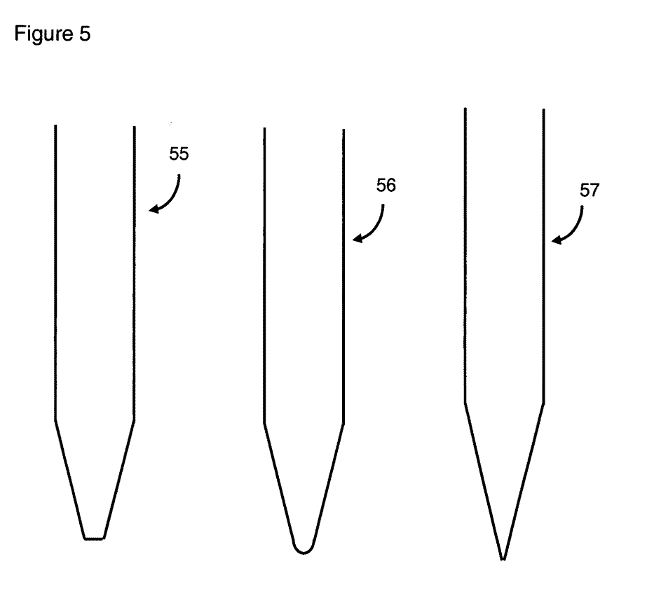

The exact shape of the silicon-containing emitters is not critical. In FIG. 5, a truncated emitter 55 has a flattened tip, a rounded emitter 56 has a rounded tip, and a sharpened emitter 57 has a pointed tip. All emitters 55, 56, 57 provide low particle counts when installed in an in-line ionizer that is driven by a high frequency AC voltage.

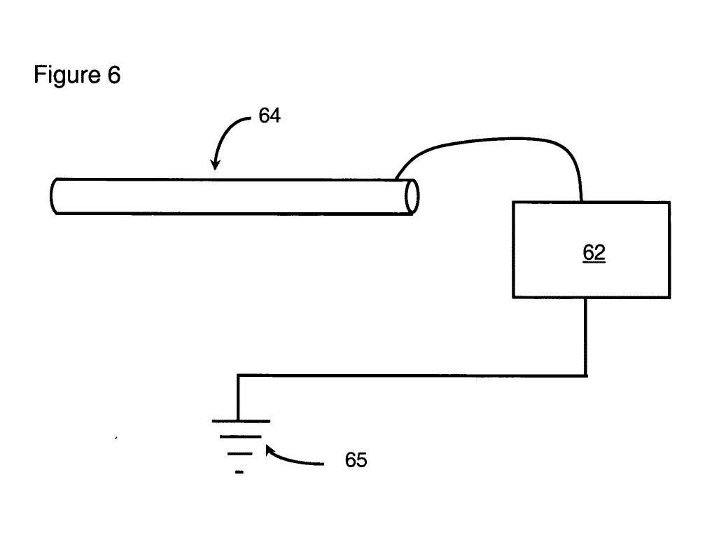

FIG. 6 shows a filament-style emitter 64 connected to a high voltage power source 62. The emitter 64 creates ions when the voltage between the emitter 64 and the reference electrode 65 exceeds the corona onset voltage. When this emitter 64 is coated with silicon oxide, it produces low particle counts if the emitter 64 is employed in an in-line ionizer and powered with a high frequency AC voltage.

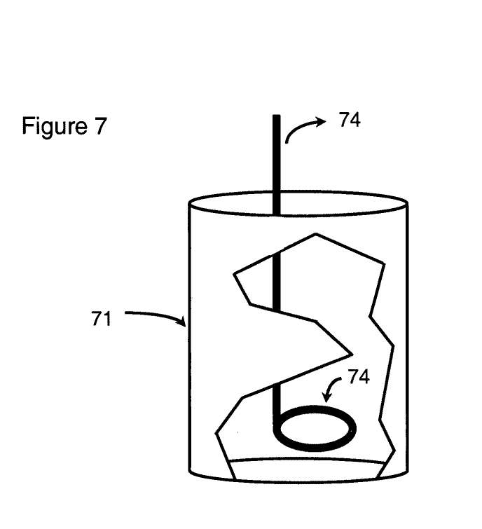

FIG. 7 shows a loop-shaped emitter 74 that is disposed within an air (or nitrogen or argon) nozzle 71. If the emitter 74 surface contains at least 47% silicon, it will produce low particle counts when powered with a high frequency AC voltage.

We claim:

1. An ionizer that produces both positive and negative ions and generates low particle counts greater than 10 nanometers in diameter comprising:
a chassis
a high frequency AC power supply contained within said chassis, which
operates between 1.0 kiloHertz and 100 kilohertz,
produces a positive peak voltage of at least 5 kilovolts above ground, and
produces a negative peak voltage of at least 4.5 kilovolts below ground;
one or more corona emitters that
contain greater than or equal to 47% silicon by weight,
connect to a common electrical bus,
receive the output from said high frequency AC power supply, and
generate said positive and negative ions.

2. Claim 1 where said emitters comprise any one chemical composition selected from a group consisting of single crystal silicon, deposited silicon, silicon carbide, and silicon oxide.

3. Claim 2 where the purity of said single crystal silicon or said deposited silicon exceeds 99 percent silicon by weight.

4. Claim 2 where the purity of said silicon carbide exceeds 99 percent silicon carbide by weight.

5. Claim 2 where the purity of said silicon oxide exceeds 99 percent silicon oxide by weight.

6. Claim 2 where said silicon oxide is disposed as a film which covers an emitter tip.

7. Claim 1 where said high frequency AC power supply produces a voltage output during active time intervals, and does not produce a voltage output during inactive time intervals.

8. Claim 1 where said emitters possess—
a shaft which directly connects to said ionizer, and
a tip which has a smaller cross section than said shaft and points away from said ionizer.

9. Claim 1 where said emitters are disposed as wires or coated wires.

10. Claim 9 where said wires or coated wires are shaped as loops.

11. Claim 9 where said wires comprise single crystal silicon, deposited silicon, silicon carbide, or silicon oxide.

12. Claim 9 where a coating on said coated wires comprises single crystal silicon, deposited silicon, silicon carbide, or silicon oxide.

13. A method of creating a balanced ionizer with low generation of particles greater than 10 nanometers in diameter comprising:
producing a high frequency AC voltage with a high frequency AC power supply where,
said high frequency is between 1.0 kiloHertz and 100 kilohertz,
said AC voltage has a positive peak voltage of at least 5 kiloVolts above ground, and
said AC voltage has a negative peak voltage of at least 4.5 kiloVolts below ground;
connecting said high frequency AC voltage to one or more emitters where
said emitters have a chemical composition that is at least 47% silicon by weight; and
generating ions with the combination of said high frequency AC voltage and said emitters.

14. Claim 13 where said emitters include single crystal silicon, deposited silicon, silicon carbide, or silicon oxide.

15. Claim 13 where said emitters possess—
a shaft which connects to said ionizer, and
a tip which has a smaller cross section than said shaft.

16. Claim 13 where said emitters are disposed as wires or coated wires.

17. Claim 16 where said wires or coated wires are shaped as loops.

18. An ionizer that produces both positive and negative ions and has low generation of particle greater than 10 nanometers in diameter comprising:
a high frequency AC power supply, which
operates between 1.0 kiloHertz and 100 kilohertz,
produces a positive peak voltage of at least 5 kiloVolts above ground, and
produces a negative peak voltage of at least 4.5 kilovolts below ground;
one or more emitters covered with a coating where
said coating contains greater than 47% silicon by weight, and
said emitters
connect to the output terminal of said high frequency AC power supply, and
generate said positive and negative ions with said high frequency AC power supply.

19. Claim 18 where said coating includes single crystal silicon, deposited silicon, silicon carbide, or silicon oxide.

20. Claim 18 where said emitters possess any one shape selected from a group consisting of a wire, a loop, and a shaft with a tip.
